(19) United States
(12) Patent Application Publication
(10) Pub. No.: US 2012/0008855 A1
(43) Pub. Date: Jan. 12, 2012

(54) STEREOSCOPIC IMAGE GENERATION APPARATUS AND METHOD

(76) Inventors: Ryusuke HIRAI, Tokyo (JP); Takeshi MITA, Yokohama-shi (JP); Nao MISHIMA, Inagi-shi (JP); Kenichi SHIMOYAMA, Tokyo (JP); Masahiro BABA, Yokohama-shi (JP)

(21) Appl. No.: 13/052,937

(22) Filed: Mar. 21, 2011

(30) Foreign Application Priority Data
Jul. 8, 2010 (JP) 2010-156136
Feb. 10, 2011 (JP) 2011-027420

(51) Int. Cl. G06K 9/00

(52) U.S. Cl. 382/154

(57) ABSTRACT

According to embodiments, a stereoscopic image generation apparatus for generating a disparity image based on at least one image and depth information corresponding to the at least one image is provided. The apparatus includes a calculator, selector and generator. The calculator calculates, based on the depth information, evaluation values that assume larger values with increasing hidden surface regions generated upon generation of disparity images for respective viewpoint sets each including two or more viewpoints. The selector selects one of the viewpoint sets based on the evaluation values calculated for the viewpoint sets. The generator generates, from the at least one image and the depth information, the disparity image at a viewpoint corresponding to the one of the viewpoint sets selected by the selector.

### CROSS-REFERENCE TO RELATED APPLICATIONS

This application is based upon and claims the benefit of priority from Japanese Patent Application No. 2010-156136, filed Jul. 8, 2010; the entire contents of which are incorporated herein by reference.

### FIELD

Embodiments described herein relate generally to a disparity image generation apparatus and method.

### BACKGROUND

In recent years, development of consumer-use stereoscopic display devices has been activated, while most images are two-dimensional images. Hence, a method of generating a stereoscopic image from a two-dimensional image has been proposed. In order to generate a stereoscopic image, an image from a viewpoint which is not included in a source image often has to be generated. In this case, pixels have to be interpolated for a portion hidden behind an object in the source image (to be referred to as a hidden surface region hereinafter).

Hence, a method of interpolating pixel values of a hidden surface region has been proposed. A technique for generating pixel values of a hidden surface region which is generated upon generation of a three-dimensional image from a two-dimensional image based on those corresponding to pixels of edge portions of partial images which neighbor the hidden surface region is available. In the aforementioned related art, upon interpolating pixel values of a hidden surface region in a disparity image, pixel values which express an object on the front side are often unwantedly interpolated although the hidden surface region is a back-side region.

### BRIEF DESCRIPTION OF THE DRAWINGS

FIG. 1 is a block diagram showing a stereoscopic image generation apparatus according to the first embodiment;

FIG. 2 is a view for explaining the relationship between pixel positions of an image and coordinates in the horizontal and vertical directions;

FIGS. 3A and 3B are conceptual views showing the relationship between a disparity amount and depth value;

FIGS. 4A and 4B are views for explaining a viewpoint axis;

FIG. 5 is a view showing viewpoint axes when images are captured using a plurality of cameras which are arranged two-dimensionally;

FIG. 6 is a view showing an example of an input image and depth information corresponding to that image;

FIG. 7 is a view showing a depth distribution and viewpoint sets on a plane which passes through a line segment MN;

FIGS. 8A and 8B are views showing examples of disparity images generated from an input image;

FIG. 9 is a flowchart showing the operation of the stereoscopic image generation apparatus;

FIG. 10 is a flowchart showing an example of the detailed operations executed by a calculator;

FIG. 11 is a flowchart showing a modification of the detailed operations executed by the calculator;

FIG. 12 is a conceptual view showing the relationship between a viewpoint and hidden surface area;

FIG. 13 is a conceptual view showing the relationship between a viewpoint and hidden surface area;

FIG. 14 is a flowchart showing a modification of the detailed operations executed by the calculator;

FIG. 15 is a block diagram showing a stereoscopic image generation apparatus according to the second embodiment; and

FIG. 16 is a block diagram showing a stereoscopic image generation apparatus according to the third embodiment.

### DETAILED DESCRIPTION

Embodiments will be described hereinafter. Note that the same reference numerals denote components and processes which perform the same operations, and a repetitive description thereof will be avoided.

In general, according to embodiments, a stereoscopic image generation apparatus for generating a disparity image based on at least one image and depth information corresponding to the at least one image is provided. The apparatus includes a calculator, selector and generator. The calculator calculates, based on the depth information, evaluation values that assume larger values with increasing hidden surface regions generated upon generation of disparity images for respective viewpoint sets each including two or more viewpoints. The selector selects one of the viewpoint sets based on the evaluation values calculated for the viewpoint sets. The generator generates, from the at least one image and the depth information, the disparity image at a viewpoint corresponding to the one of the viewpoint sets selected by the selector.

### First Embodiment

A stereoscopic image generation apparatus according to this embodiment generates, based on at least one input image and depth information corresponding to the input image, disparity images at viewpoints different from the input image. Disparity images generated by the stereoscopic image generation apparatus of this embodiment may use arbitrary methods as long as stereoscopic viewing is allowed. Although either of field sequential and frame sequential methods may be used, this embodiment will exemplify a case of the frame sequential method. An input image is not limited to a two-dimensional image, but a stereoscopic image may also be used.

Depth information may be prepared in advance by an image provider. Alternatively, depth information may be estimated from an input image by an arbitrary estimation method.

Furthermore, depth information may be that whose dynamic range is compressed or expanded. Various methods of supplying an input image and depth information may be used. For example, a method of acquiring at least one input image and depth information corresponding to the input image by reading information via a tuner or that stored in an optical disc is available. Alternatively, a method in which a two-dimensional image or stereoscopic image having a disparity is externally supplied, and a depth value is estimated before such image is input to the stereoscopic image generation apparatus may be used.

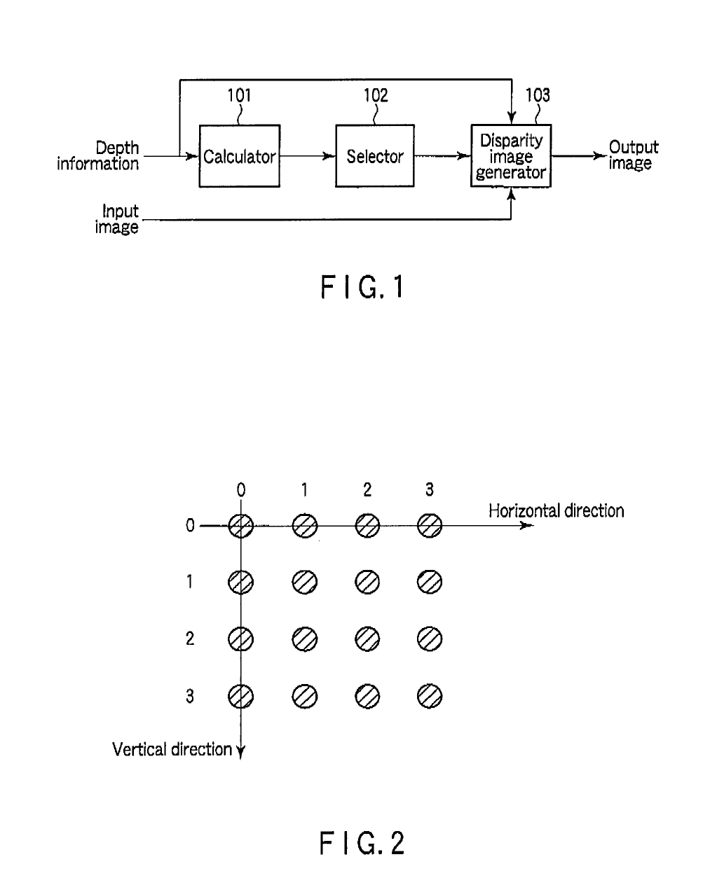

FIG. 1 is a block diagram showing a stereoscopic image generation apparatus of this embodiment. The stereoscopic image generation apparatus includes a calculator 101, selector 102, and disparity image generator 103. The stereoscopic image generation apparatus generates disparity images at viewpoints different from an input image based on depth information corresponding to the input image. By displaying disparity images having a disparity from each other, a viewer can perceive them as a stereoscopic image.

The calculator 101 calculates, using depth information (alone), an evaluation value that assumes a larger value as a hidden surface region, which is generated upon generation of disparity images, becomes larger, for each of a plurality of candidate viewpoint sets. The calculated evaluation values are sent to the selector 102 in association with set information. Note that the calculator 101 need not generate disparity images in practice, and need only estimate an area of a hidden surface region generated in an assumed viewpoint set. In this embodiment, a hidden surface area indicates the total number of pixels which belong to a hidden surface region. The number of viewpoints included per set is not limited as long as it assumes a value equal to or larger than 2. A candidate viewpoint indicates an imaginarily defined image capturing position.

The selector 102 selects one candidate viewpoint set based on the evaluation values calculated for respective sets by the calculator 101. As a selection method, a candidate viewpoint set corresponding to a minimum evaluation value is preferably selected. In this case, one of a plurality of candidate viewpoint sets, which minimizes a hidden surface area generated upon generation of disparity images, is selected as a viewpoint set for disparity image generation.

The disparity image generator 103 generates disparity images at viewpoints corresponding to the viewpoint set selected by the selector 102.

An imaginary viewpoint at which the input image is captured will be referred to as a first viewpoint hereinafter. Note that the first viewpoint may often include a plurality of viewpoints (for example, the input image has a plurality of images captured from a plurality of viewpoints). Also, viewpoints included in the viewpoint set selected by the selector 102 will be referred to as a second viewpoint set hereinafter. The disparity image generator 103 generates imaginary images captured from the second viewpoint positions.

FIG. 2 is a view for explaining the relationship between pixel positions of an image (including the input image and disparity images) and coordinates in the horizontal and vertical directions. The pixel positions of the image are indicated by gray dots, and horizontal and vertical axes are described. In this way, the respective positions are set at integer positions on the coordinates in the horizontal and vertical directions. A vector has an upper left end (0, 0) of the image as an origin unless otherwise specified.

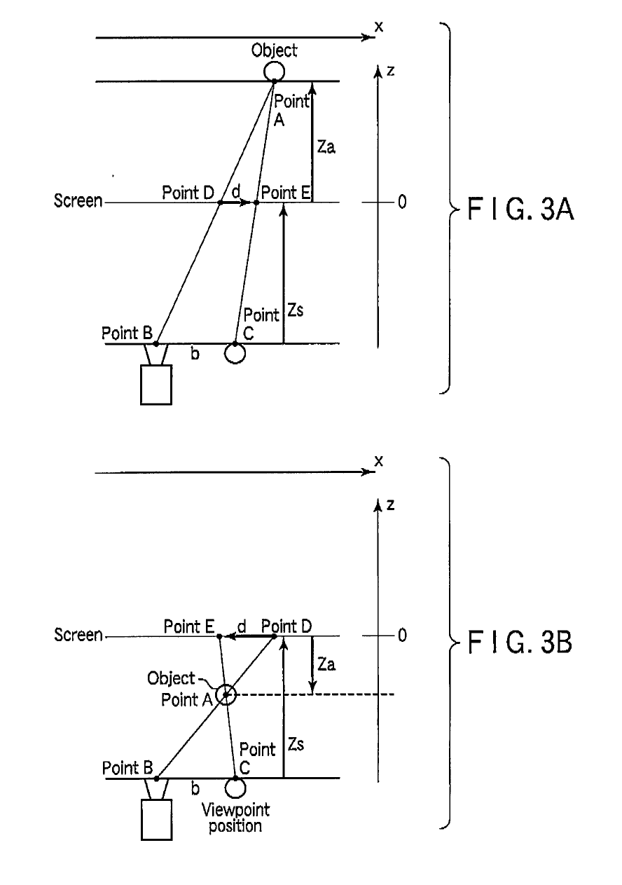

FIGS. 3A and 3B are conceptual views showing the relationship between a disparity amount and depth value. An x axis extends along the horizontal direction of a screen. A z axis extends along the depth direction. A position is set back farther from an image capturing position with increasing the depth. z=0 indicates an imaginary position of a display surface. A line DE is located on the display surface. A point B indicates the first viewpoint. A point C indicates the second viewpoint. In FIGS. 3A and 3B, assuming that the viewer views an image at a position parallel to the screen, the line DE is parallel to a line BC. Let b be the distance between the points B and C. An object is located at a point A of a depth Za. Note that the depth Za is a vector of which a positive direction corresponds to a positive direction of the depth direction. A point D indicates a display position of the object on an input image. Pixel positions on a screen at the point D are represented by a vector i. A point E indicates a position when the object is displayed on disparity images to be generated. That is, a length of the line segment DE corresponds to a disparity amount.

FIG. 3A shows the relationship between the depth value and disparity amount when an object on the back side of the screen is displayed. FIG. 3B shows the relationship between the depth value and disparity amount when an object on the front side of the screen is displayed. In FIGS. 3A and 3B, the positional relationship between the points D and E on the x axis is reversed. In order to reflect the positional relationship between the points D and E, a disparity vector d(i) having the point D as a start point and the point E as an end point is defined. Element values of the disparity vector follow the x axis. When the disparity vector is defined, as shown in FIGS. 3A and 3B, the disparity amount with respect to a pixel position i is expressed by the vector d(i).

Letting Zs be the vector from the viewer to screen, since triangles ABC and ADE have a similarity relationship, |Za+Zs|:|Za|=b:|d(i)| holds. Upon solving this for |d(i)|, since the x and z axes are set, as shown in FIGS. 3A and 3B, we have:

$$d ( i ) = b \frac{{Z}_{a}}{\vert {Z}_{a} + {Z}_{s} \vert} \qquad ( 1 )$$

That is, the disparity vector d(i) can be uniquely calculated from the depth value Za(i) of the pixel position i. Hence, in the following description, a description “disparity vector” can also be read as “depth value”.

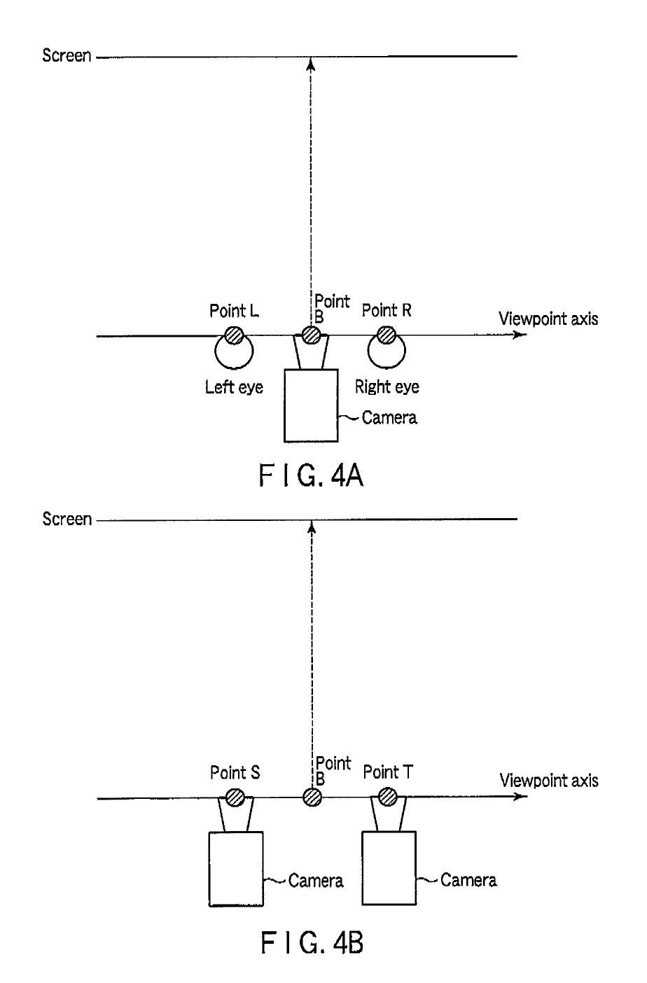

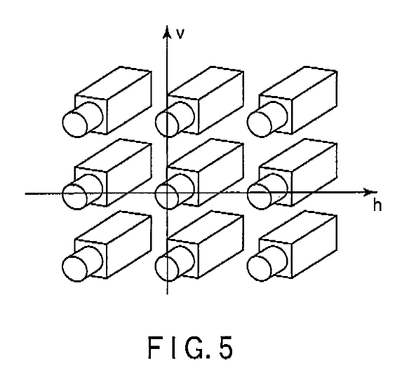

Viewpoints will be described below with reference to FIGS. 4 and 5.

FIG. 4 is a view for explaining a viewpoint axis. FIG. 4A shows the relationship between a screen and viewpoints when viewed from the same direction as in FIGS. 3A and 3B. A point L indicates the position of a left eye, a point R indicates the position of a right eye, and a point B indicates the image capturing position of the input image. A viewpoint axis, which passes through the points L, B, and R, assumes a positive value in the right direction of FIG. 4A, and has the point B as an origin, is defined. Alternatively, FIG. 4B shows the relationship between a screen and viewpoints when viewed from the same direction as in FIGS. 3A and 3B. In the case of FIG. 4B, respective images are captured at the points S and T as input images. A viewpoint axis, which assumes a positive value in the right direction of FIG. 4B, and has the point B as an origin, is also defined. The point B in the case of FIG. 4B is the middle point of the line passing through points S and T, i.e., two image capturing positions.

These axes are parallel to the line BC in FIGS. 3A and 3B. On the viewpoint axis, a coordinate (scale) obtained by normalizing an average human inter-eye distance to “1” is used in place of a distance on a real space. Based on such definition, in FIG. 4, the point R is located at 0.5 and the point L is located at −0.5 on the viewpoint axis. In the following description, a viewpoint is expressed by a coordinate on the viewpoint axis. In this way, equation (1) can be rewritten as a function according to a viewpoint (scale) like:

d(i,scale)=scale×d(i) (2)

In this way, for example, a pixel value I(i, 0.5) at a pixel position i of an image when viewed from a viewpoint “0.5” can be expressed by:

I(1,0.5)=I(i−d,) (3)

The case has been explained wherein the input image is obtained based on one viewpoint. Also, when two or more disparity images are provided, a viewpoint axis can be similarly set. That is, a viewpoint axis can be set under the assumption that a left-eye image is captured at −0.5 on the viewpoint axis and a right-eye image is captured at 0.5 on the viewpoint axis. Furthermore, even when images, which are captured by arranging a plurality of cameras in the vertical and horizontal directions, as shown in FIG. 5, are input, viewpoint axes can be set like v and h axes in FIG. 5.

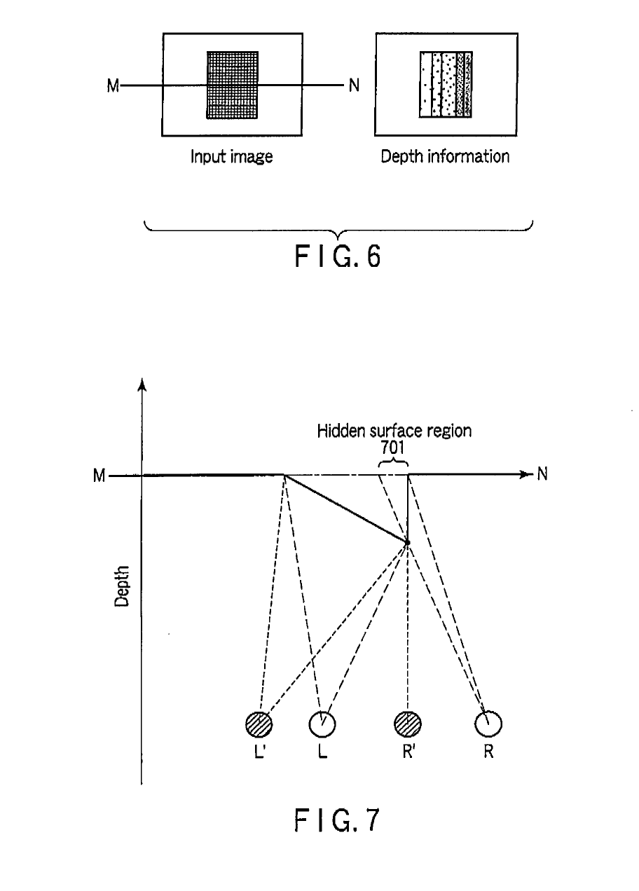

The relationship between the number of pixels which belong to a hidden surface region, and viewpoints will be described below with reference to FIGS. 6, 7, 8A, 8B, and 9.

FIG. 6 is a view showing an example of an input image and depth information corresponding to that image. The depth information indicates a position closer to the viewer side as it is closer to black.

FIG. 7 is a view showing the depth distribution and viewpoint sets on a plane which passes through a line segment MN assumed on the input image shown in FIG. 6. A bold line represents depth values. Two viewpoint sets (L, R) and (L′, R′) are assumed. L and L′ are left-eye viewpoints, and R and R′ are right-eye viewpoints. The distance between L and R and that between L′ and R′ are preferably average interocular distance, respectively. When disparity images when viewed from the viewpoint set (L, R) are generated, a hidden surface region 701 is geometrically generated, as shown in FIG. 7, when viewed from the viewpoint R. The hidden surface region indicates a region located on a portion which is invisible from a certain viewpoint on the input image since it is hidden behind another object or surface.

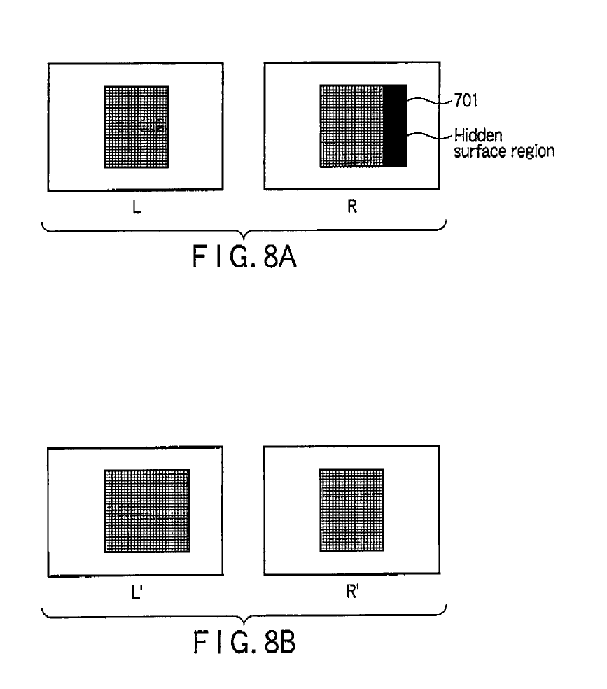

FIG. 8A shows disparity images at the viewpoint L and R, which are generated from the input image shown in FIG. 6. A disparity image including the hidden surface region 701 is generated. Since the input image does not include any information of the hidden surface region, pixel values, which are estimated by an arbitrary method, have to be interpolated. However, it is difficult to correctly estimate pixel values of the hidden surface region, and image quality is more likely to deteriorate.

FIG. 8B shows disparity images at the viewpoint L′ and R′, which are generated from the input image shown in FIGS. 6 and 7. In case of the example shown in FIG. 7, when disparity images viewed from the viewpoint set (L′, R′) are generated, no hidden surface region is generated. Therefore, disparity images can be generated without including any hidden surface region, as shown in FIG. 8B. As can be seen from the above description, by adaptively changing the viewpoint sets according to the input depth information, the total number of pixels which belong to a hidden surface region changes.

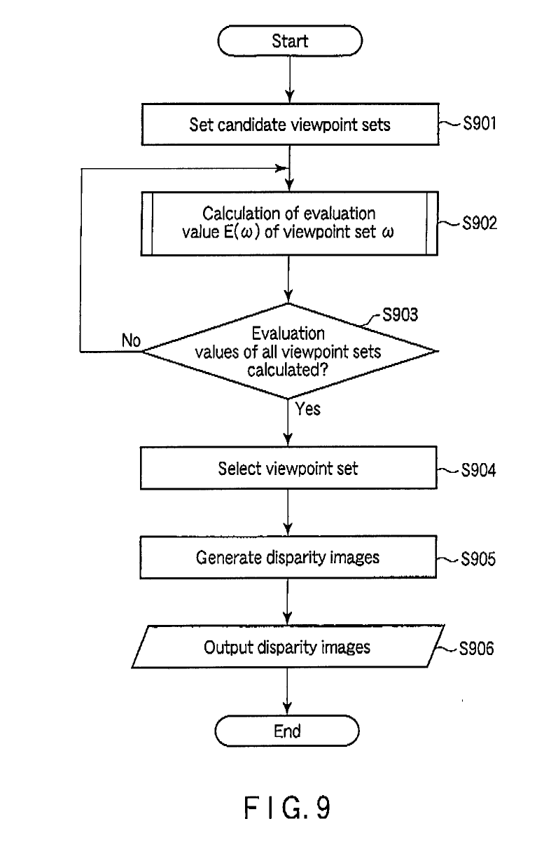

FIG. 9 is a flowchart for explaining the operation of the stereoscopic image generation apparatus.

The calculator 101 sets candidate viewpoint sets in accordance with the viewpoint axis (S901). For example, upon generation of a left-eye disparity image and right-eye disparity image, each set includes two viewpoints. A set Ω indicates candidate viewpoint sets. Note that candidate viewpoint sets may be set in advance. An example in which the set Ω is set as follows will be described below.

Ω={(−0.5,0.5),(−1.0,0.0),(0.0,1.0)}

In this example, three candidate viewpoint sets are used, but an arbitrary number of sets may be used as long as a plurality of viewpoint sets are used. Note that a larger calculation volume is required with increasing the number of candidates. For this reason, it is preferable to set the number of candidates according to an allowable calculation volume. When one element of each viewpoint set includes the same viewpoint as that at which the input image is captured, the calculation volume in the subsequent disparity image generation processing can be reduced. For example, the sets (−0.1, 0.0) and (0.0, 1.0) in the above example include the same viewpoint as that at which the input image is captured.

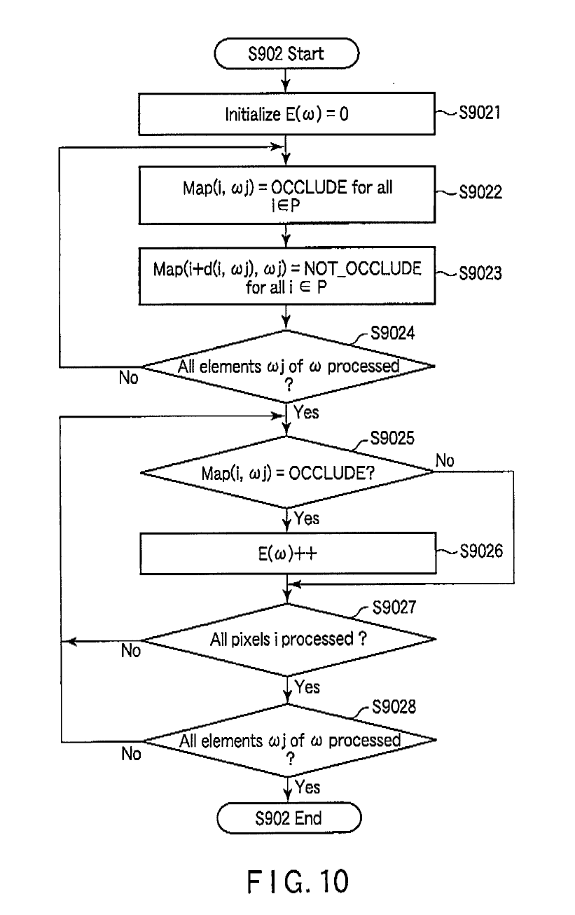

The calculator 101 calculates an evaluation value E(ω) for each viewpoint set ω included in the set Ω (S902). The evaluation value E(ω) uses a value which increases with increasing the number of pixels which belong to a hidden surface region, as described above. Various calculation methods of the evaluation value E(ω) are available. In one method, using the aforementioned disparity vector, input pixel values are assigned to positions pointed by the disparity vector, and the number of pixels to which no pixel value is assigned can be calculated. A practical calculation method will be described later using FIG. 10.

The calculator 101 determines whether or not evaluation values for all the viewpoint sets set in step S901 have been calculated (S903). If the viewpoint sets for which evaluation values are to be calculated still remain (NO in step S903), the process returns to step s902 to calculate an evaluation value E(ω) for a viewpoint set for which an evaluation value is not calculated. If the evaluation values are calculated for all the viewpoint sets set in step s901 (YES in step S903), the process advances to step S904.

The selector 102 selects a viewpoint set used in disparity image generation based on the evaluation values calculated in step S902 (s904). It is preferable to select a viewpoint set corresponding to a minimum evaluation value.

The disparity image generator 103 generates disparity images corresponding to the viewpoint set selected in step S904. For example, when a viewpoint set (0.0, 1.0) is selected in step s904, the generator 103 generates a disparity image corresponding to a viewpoint “1.0” (S905). Note that an image corresponding to a viewpoint “0.0” is the input image, and need not be generated again in step S905.

The disparity images generated in step S905 are output, thus ending the processing for one input image.

FIG. 10 is a flowchart showing an example of the detailed operations in step s902 executed by the calculator 101.

The calculator 101 initializes E(ω) to zero (S9021). The calculator 101 generates Map(i, ωⱼ) using the input depth information. Map(i, ωⱼ) represents whether or not each pixel in an image corresponding to a certain viewpoint ωj of a viewpoint set ω to be processed is a pixel in the hidden surface region. The calculator 101 sets, as an initial value, Map(i, ωⱼ)=OCCLUDE for a pixel iεP on an image corresponding to the viewpoint ωj (S9022) (where P indicates all pixels of the input image). In the equation, “OCCLUDE” means that a pixel indicated by the left-hand side belongs to a hidden surface region. Next, the calculator 101 rewrites a value at a position of the pixel iεP, which is shifted by disparity vector d(i, ωⱼ) to Map(i+d(i, ωⱼ), ωⱼ)=NOT_OCCLUDE (S9023). Note that disparity vector d(i, ωⱼ) may be calculated from depth information, where “NOT_OCCLUDE” means that a pixel indicated by the left-hand side does not belongs to a hidden surface region. Then, the calculator 101 determines whether or not the processes in steps S9022 to S9023 for elements ωj of all ω are completed (S9024). If it is determined that the processes in steps S9022 to S9023 for elements ωj of all ω are not completed (NO, in step S9024), the process returns to step S9022.

If it is determined that the processes in steps S9022 to S9023 for elements ωj of all ω are completed (YES, in step S9024), the calculator 101 determines whether or not Map(i, ωⱼ)=OCCLUDE for all pixels iεP of Map(i, ωⱼ) (S9025). If Map(i, ωⱼ)=OCCLUDE (YES in step S9025), the calculator 101 adds the corresponding number of pixels to E(ω) (S9026). That is, for all pixels iεP of mapping function Map(i, ωⱼ), the number of pixels which satisfy Map(i, ωⱼ)=OCCLUDE is added to E(ω). If Map(i, ωⱼ) is not OCCLUDE (Map(i, ωⱼ)=NOT_OCCLUDE, i.e., NO, in step S9025), the process advances to step s9027, skipping step s9026.

In this way, an evaluation value E(ω) indicating the number of pixels, to which no pixel value is assigned by the disparity vector, that is, which belong to a hidden surface region, can be obtained.

In step S9027, the calculator 101 determines whether or not the processes in steps S9025 and S9026 for all pixels i are completed (S9027). If the processes in steps S9025 and S9026 for all pixels i are not completed (NO, in step S9027), the process advances to step s9025. If the processes in steps S9025 and S9026 for all pixels i are completed (YES, in step S9027), the calculator 101 determines whether or not the processes in steps S9025 and S9026 for elements ωj of all ω are completed (S9028). If the processes in steps S9025 and S9026 for elements ωj of all ω are not completed (NO, in step S9028), the process returns to step S9025. If the processes in steps S9025 and S9026 for elements ωj of all ω are completed (Yes, in step S9028), the process terminates.

(Modification 1)

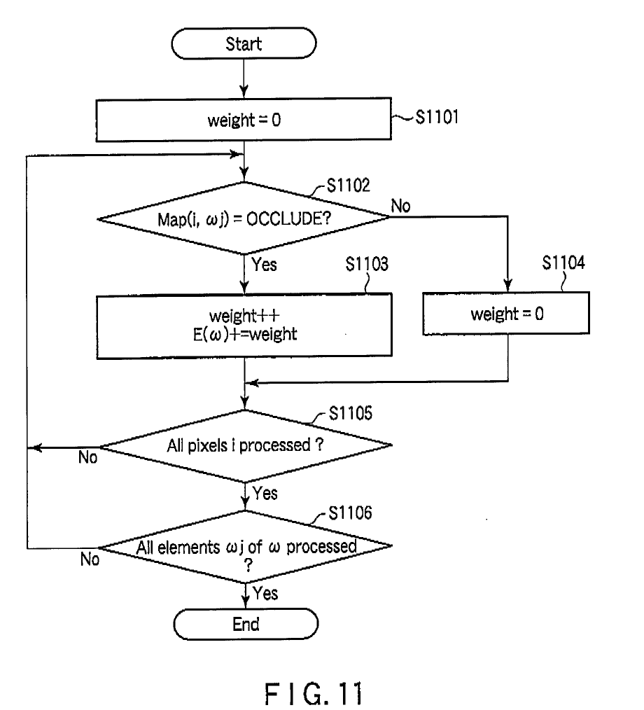

FIG. 11 is a flowchart for explaining another example of the evaluation value calculation method executed by the calculator 101. In the processing shown in FIG. 10, the number of pixels which belong to a hidden surface region is simply calculated. If a hidden surface region is very small (a few pixels concatenated), it is enough to make reasonable pixel values for the hidden region by a interpolation techniques. For this reason, pixels of a hidden surface region do not cause serious deterioration of image quality in some cases. Conversely, when pixels of a hidden surface region are concentrated, it is difficult to estimate pixel values of the hidden surface region by interpolation techniques. FIG. 11 shows the evaluation value calculation method in consideration of this difficulty. The calculator 101 can process by replacing steps S9025 to S9028 in FIG. 10 by steps S1101 to S1108.

Initially, an internal variable weight is initialized to 0 (S1101). It is determined whether Map(i, ωⱼ)=OCCLUDE for a pixel iεP (S1102). If Map(i, ωⱼ)=OCCLUDE for a pixel iεP (YES in step S1102), the calculator 101 increments weight, and then adds weight to E(ω) (S1103). If Map(i, ωⱼ)≠OCCLUDE (NO in step S1102), the calculator 101 sets weight=0 (S1104). At this time, the selection order of pixels i follows the raster scan order. According to the operation, as the number of times increase wherein continuous pixels selected by the raster scan order are determined to be pixels which belong to the hidden surface in step s1102, the value of weight become large. As the value of weight become large, increment of E(ω) in step S1103 become large.

Then, the calculator 101 determines whether or not the processes in steps S1102 to S1104 for all pixels i are completed (S1105). If the processes in steps S1102 to S1104 for all pixels i are not completed (NO, in step s1105), the process returns to step s1102. If the processes in steps S1102 to S1104 for all pixels i are completed (YES, in step S1105), the calculator 101 determines whether or not the processes in steps S1102 to S1104 for elements ωj of all ω are completed (S1106). If the processes in steps S1102 to S1104 for elements ωj of all ω are not completed (NO, in step S1106), the process returns to step S1102. If the processes in steps S1102 to S1104 for elements ωj of all ω are completed (Yes, in step S1106), the process terminates.

In this case, the raster scan order is used, but the scan order may be changed to, for example, a Hilbert scan order in which a region in an image is scanned by one stroke. Furthermore, in place of E(ω)+=weight in step S1103, E(ω)+=2̂weight may be used to increase an evaluation value as a hidden surface region continues.

When a hidden surface region appears near the center of a screen, deterioration of image quality tends to subjectively stand out. In consideration of this, E(ω)+=exp(−(Norm(i−c))) may be used in place of E(ω)++ in step s1103 in FIG. 11 to increase an evaluation value as a pixel position i is closer to the screen center. Note that c is a vector which represents the central position of the screen. Also, Norm( ) is a function which represents a norm value of the vector, and a general L1 norm or L2 norm is used. Likewise, E(ω)+=weight*exp(−Norm((i−c))) may be used in place of E(ω)+=weight in step s1103 in FIG. 11 to provide the same effect.

(Modification 2)

When viewpoint sets are temporally discontinuous, temporal connections of images are lost due to discontinuity, resulting in subjectively serious deterioration of image quality. Hence, a derivation method of an evaluation value E(ω), which causes the selector 102 to select a viewpoint set which is as close as possible to a viewpoint set ω^{t-1} used upon generation of disparity images one frame before in chronological order, as will be described later, may be used. More specifically, E(ω)+=(1−exp(−(Norm(ω−ω^{t-1})))) may be used in place of E(ω)++ in step S9026 in FIG. 10, so as to decrease an evaluation value as a viewpoint set ω is closer to the viewpoint set ω^{t-1} selected at the time of generation of the previous frame. Norm( ) uses a general L1 norm or L2 norm, as described above. Likewise, E(ω)+=weight*(1−exp(−(Norm(ω−ω^{t-1})))) may be used in place of E(ω)+=weight in step S1103 in FIG. 11 to provide the same effect.

As is understood from a geometrical relationship, the size of a hidden surface region can be calculated from first derivations of depth values of neighboring pixels in the input depth information. This will be explained below.

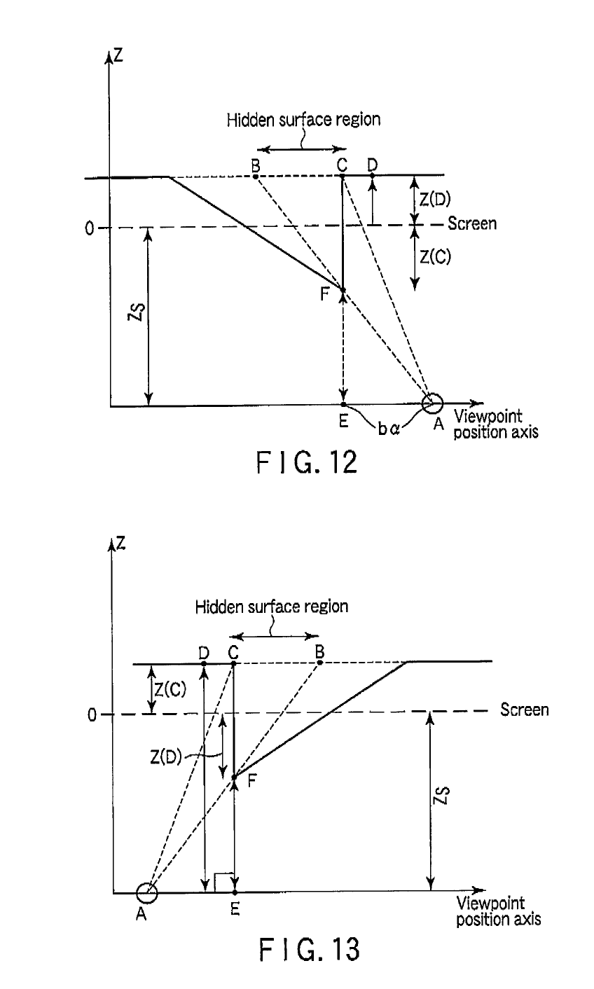

FIG. 12 is a view when viewed from the vertical direction as in FIGS. 3A and 3B, and so forth. Assume that a point A is located at a position α on the viewpoint axis. That is, letting b be interoclular distance, the length of a line segment AE is bα. Points C and D represent pixel positions, and are pixels that are adjacent to each other in this case. A screen is set at an origin of a coordinate z axis that depth values follow. Assume here that negative values of the z axis are always greater than −Zs. This is because a pixel along the z axis never beyond the viewer position. Along the z axis, a depth value z(C) of the point C, and a depth value z(D) of the point D are represented. An origin of the viewpoint axis is a point E. A bold line represents given depth values. In this case, as can be seen from the above description, the length of a line segment BC corresponds to the size of a hidden surface region. Using a similarity relationship between ΔAEF and ΔBCF, the length of this line segment BC is described by:

$$\overline{BC} = \frac{\vert z ( C ) - z ( D ) \vert}{{Z}_{s} + z ( C )} b α \qquad ( 4 )$$

for α≧0. This is because if a gradient Z(C)−Z(D) of z(C) and z(D) is negative, a hidden surface region is generated when α>1.

FIG. 13 is another conceptual view showing the relationship between a viewpoint and hidden surface area. FIG. 13 shows a case in which FIG. 12 is reversed horizontally. Note that the positions of points C and D are interchanged so that a position relationship between the points C and D is identical to that of FIG. 12. That is, FIG. 13 shows a case in which a gradient z(C)−z(D) of the depth value is greater than zero (i.e., z(C)−z(D)>0). In this case, using the geometrical relationship as in the above case, the length of a line segment BD can be described by;

$$\overline{BD} = \frac{\vert z ( D ) - z ( C ) \vert}{{Z}_{s} + z ( D )} b α \qquad ( 5 )$$

for α<0. To summarize these relationships, a length L(α, i, j) of the line segment BC which represents the size of a hidden surface region is described by:

$$L ( a , i , j ) = \{ \begin{matrix}\frac{\vert z ( i ) - z ( j ) \vert}{{Z}_{s} + z ( i )} b α & α > 0 and z ( i ) - z ( j ) < 0 \\ \frac{\vert z ( j ) - z ( i ) \vert}{{Z}_{s} + z ( j )} b α & α < 0 and z ( i ) - z ( j ) \geq 0\end{matrix} \qquad ( 6 )$$

wherein pixel positions i and j are of neighboring pixels.

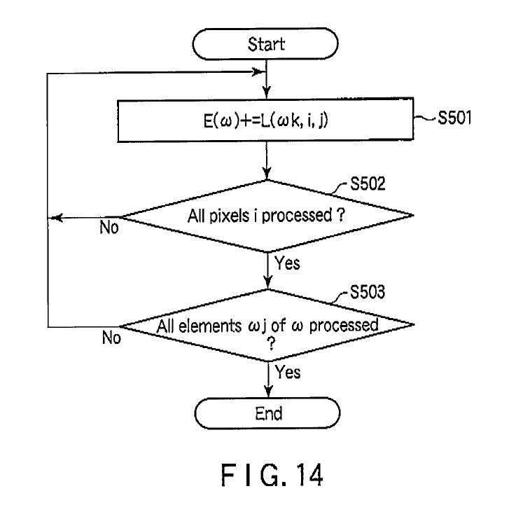

FIG. 14 is a flowchart for explaining the calculation method of an evaluation value E(ω) using L. As shown by the steps from S501 to S503 in FIG. 14, the calculator 101 can also calculate evaluation values for all viewpoints included in elements ω of the set Ω and for all pixels iεP by:

E(ω)+=L(ωk,i,j) (7)

where j indicates the next pixel position when i is scanned in the raster scan order. Equation (7) can also be rewritten as the following equation (8), where evaluation values E(ω) that assume a larger value with increasing hidden surface region may be calculated:

E(ω)=pow(2,L(ωk,i,j)) (8)

where Pow(x, y) is a function which returns a value of the y-th power of x. Furthermore, using a position vector c which represents a central position of the screen, evaluation values E(ω) that assume a larger value with hidden surface region closing to the central position of the screen may be calculated using the following equation:

E(ω)+=L(ωk,i,j)*exp(−Norm((i−c) (9)

The following equation may also be used so that a selected set of viewpoints to be selected does not lead to a large change in terms of time:

E(ω)+=L(ωk,i,j)*(1−exp(−Norm(ω−ω^{t-1})))) (10)

The selector 102 decides one viewpoint set ω_sel to have, as inputs, evaluation values E(ω) of respective elements of the set Ω defined by the calculator 101. ω_sel is a viewpoint set corresponding to a minimum evaluation value E(ω) in respective viewpoints of the set Ω, as given by:

$$ω\_sel = {min}_{ω ∈ Ω} E ( ω ) \qquad ( 11 )$$

Alternatively, ω closest to ω^{t-1} is selected as ω_sel from viewpoint sets which meet E(ω)<Th for a predetermined threshold Th. In this case, the predetermined threshold Th is preferably defined so that a ratio of the number of pixels which belong to a hidden surface region to the number of pixels of the entire screen is 0.1%.

The disparity image generator 103 acquires the depth information, the input image, and the viewpoint set ω_sel decided by the selector 102, and generates and outputs disparity images in accordance with disparity vectors according to the viewpoint set. In this case, a hidden surface region is generated unless an evaluation value=0. As a method of giving pixel values to the generated hidden surface region, any arbitrary existing methods may be used.

According to the first embodiment, evaluation values, which assume larger values with increasing the number of pixels of a hidden surface region that appears upon generation of disparity images, from a plurality of second viewpoint sets, which are set in advance, are calculated, and a second viewpoint set corresponding to a minimum evaluation value is selected. Then, disparity images upon imaginarily capturing images from the second viewpoint set are generated, thus reducing the number of pixels which belong to the hidden surface region, and enhancing the image quality of the disparity images.

In the above example, one two-dimensional image is input. Also, in another application, when disparity images for the right and left eyes, which are prepared in advance by the provider side, are input, images can be generated from image capturing positions different from those at the time of capturing original images. This application can meet needs on the viewer side (the viewer wants to view a more powerful stereoscopic image by increasing a disparity amount or he or she wants to reduce fatigue upon viewing a stereoscopic image by reducing a disparity amount), although a stereoscopic image has to be output based on the disparity amount already decided on the provider side. For this purpose, depth information is generated for the input right and left disparity images by, for example, a stereo matching method to generate disparity images by broadening or narrowing down a depth dynamic range, thereby meeting the viewer's needs.

### Second Embodiment

In the first embodiment, evaluation values, which assume larger values with increasing the number of pixels of a hidden surface region that appears upon generation of disparity images, from a plurality of second viewpoint sets, which are set in advance, are calculated, and a second viewpoint set corresponding to a minimum evaluation value is selected. In this case, viewpoints may time-serially cause an abrupt change. When a moving image is input, if an abrupt viewpoint change has occurred, temporal connections of stereoscopic images are lost, thus providing a feeling of strangeness to the viewer. In this embodiment, this problem is solved by softening such viewpoint change.

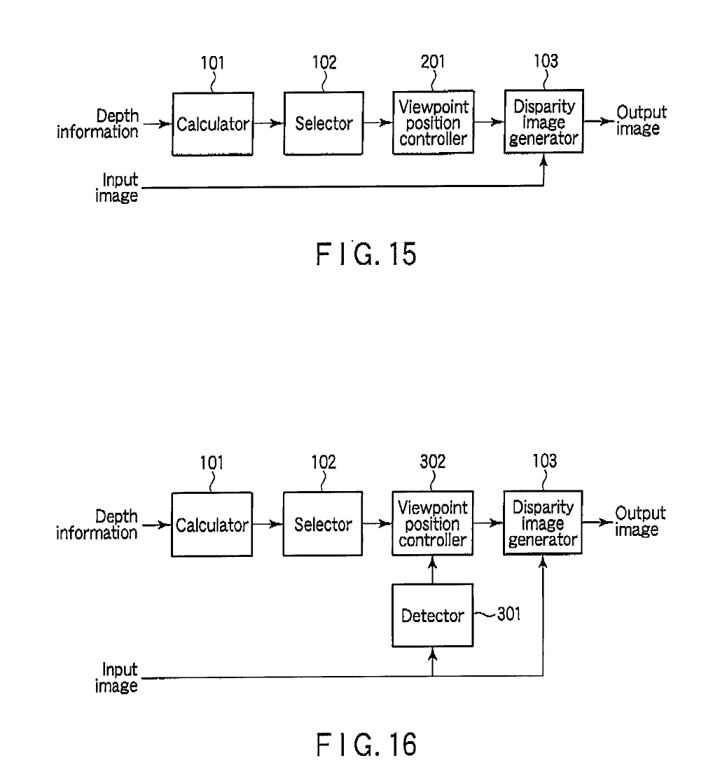

FIG. 15 is a block diagram showing a stereoscopic image generation apparatus of this embodiment. The stereoscopic image generation apparatus of this embodiment further includes a viewpoint controller 201 unlike in the first embodiment.

The viewpoint controller 201 acquires a viewpoint set ω_sel selected by a selector 102, and sends a viewpoint set ω_cor, which is corrected using internally held viewpoint sets used upon generation of previous disparity images, to a disparity image generator 103. A derivation method of the corrected viewpoint set ω_cor will be described below.

Let ω⁽ⁿ⁾ be a viewpoint set of disparity images generated n frames before. In this case, ω⁽⁰⁾ represents ω_sel. ω_cor is derived by the following FIR filter.

$$ω\_cor = {\sum }_{i = 0}^{n} {a}_{i} {ω}^{( i )} \qquad ( 12 )$$

where ai is a filter coefficient, and coefficients having characteristics that set the FIR filter as a low-pass filter are set.

Also, ω_cor can be derived using a first-order lag by:

ω_{—}cor=h*ω(0)+(1−h)ω(1)

where h is a time constant. A range of the time constant is 0<h<1.

Also, in order to reduce a calculation volume, at least one viewpoint of ω_cor may be fixed to the image capturing position of the input image.

As described above, according to the second embodiment, a stereoscopic image generation apparatus, which can provide temporal connections of stereoscopic images by suppressing an abrupt viewpoint change without providing any feeling of strangeness to the viewer can be attained.

### Third Embodiment

In the second embodiment, since viewpoints are changed slowly until a viewpoint set that can reduce the number of pixels which belong to a hidden surface region, the number of pixels which belong to the hidden surface region cannot always be reduced during this transition. On the other hand, even when a disparity position is abruptly changed at a scene change timing, a feeling of strangeness is never provided to the viewer. Hence, this embodiment provides a stereoscopic image generation method using on a more proper viewpoint set by increasing a change in disparity position at a timing when a movie scene changes.

FIG. 16 is a block diagram showing the arrangement of this embodiment. Differences from FIG. 1 are that a stereoscopic image generation apparatus further includes a detector 301 and viewpoint controller 302.

The detector 301 detects a scene change in an input image. When the detector 301 detects occurrence of a scene change before a frame to be detected, it sends a DETECT signal to the viewpoint controller 302. When the detector 301 does not detect occurrence of any scene change, it sends a NONE signal to the viewpoint controller 302.

Upon reception of the NONE signal from the detector 301, the viewpoint controller 302 executes the same processing as in a viewpoint controller 201. On the other hand, upon reception of the DETECT signal, the controller 302 sets ω⁽⁰⁾ as ω_cor in place of the output from the FIR filter. When ω_cor is derived based on a first-order lag system, the controller 302 sets h₁ as a time constant (for 1>h₁>h₀).

As described above, according to the third embodiment, a stereoscopic image generation apparatus using a more proper viewpoint set by increasing a change in disparity position at a scene change timing of a movie can be attained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A stereoscopic image generation apparatus for generating a disparity image based on at least one image and depth information corresponding to the at least one image, comprising:
a calculator configured to calculate, based on the depth information, evaluation values that assume larger values with increasing hidden surface regions generated upon generation of disparity images for respective viewpoint sets each including two or more viewpoints;
a selector configured to select one of the viewpoint sets based on the evaluation values calculated for the viewpoint sets; and
a generator configured to generate, from the at least one image and the depth information, the disparity image at a viewpoint corresponding to the one of the viewpoint sets selected by the selector.

2. The apparatus according to claim 1, wherein the selector selects the one of the viewpoint sets corresponding to a minimum value of the evaluation values.

3. The apparatus according to claim 2, wherein at least one viewpoint included in the one of the viewpoint sets is a viewpoint corresponding to the at least one image.

4. The apparatus according to claim 2, wherein the calculator calculates the evaluation values for respective viewpoint sets each including two viewpoints.

5. The apparatus according to claim 2, wherein the calculator calculates, for the respective viewpoint sets, the evaluation values based on sums of areas of hidden surface regions generated upon generation of disparity images at respective viewpoints.

6. The apparatus according to claim 2, wherein the calculator calculates the evaluation values based on difference sums of depth values between neighboring pixels in the depth information corresponding to the at least one image.

7. The apparatus according to claim 2, wherein the calculator calculates the evaluation values using a weight which assumes a larger value as a position of a hidden surface region is closer to a central position on the at least one image.

8. The apparatus according to claim 2, wherein the calculator calculates the evaluation values using a weight which assumes a larger value as a layout of pixels that belong to a hidden surface region is concentrated more.

9. The apparatus according to claim 1, wherein when the at least one image is a moving image, the calculator calculates an evaluation value for a certain viewpoint set by a method using a weight which assumes a smaller value as a viewpoint is closer to a viewpoint which has been selected in an image for which an evaluation value has already been calculated.

10. The apparatus according to claim 1, further comprising a viewpoint controller configured to suppress a change in viewpoint on a time axis when the at least one image is a moving image.

11. The apparatus according to claim 1, which further comprises a detector configured to detect a scene change when the at least one image is a moving image, and
in which a change in viewpoint before and after the detected scene change is increased.

12. A stereoscopic image generation method for generating a disparity image based on at least one image and depth information corresponding to the at least one image, comprising:
calculating, based on the depth information, evaluation values that assume larger values with increasing hidden surface regions generated upon generation of disparity images for respective viewpoint sets each including two or more viewpoints;
selecting one of the viewpoint sets based on the evaluation values calculated for the viewpoint sets; and
generating, from the at least one image and the depth information, the disparity image at a viewpoint corresponding to the one of the viewpoint sets.
